(19) United States
(12) Patent Application Publication
(10) Pub. No.: US 2024/0403987 A1
(43) Pub. Date: Dec. 5, 2024

(54) System and method for creating, maintaining and verifying voter lists

(71) Applicant: Aleksandr Khrabryi, Princeton, NJ (US)

(72) Inventor: Aleksandr Khrabryi, Princeton, NJ (US)

(21) Appl. No.: 18/799,137

(22) Filed: Aug. 9, 2024

(51) Int. Cl. G06Q 50/26

(52) U.S. Cl. CPC G06Q 50/26

(57) ABSTRACT

The system and method for creating and verifying a list of voters specific to some territory or any community have been announced, providing for: first, the capability for any user or several users together to create a community of voters, while specifying the characteristics of the positions that can be occupied by members of this community, and, second, keeping accurate records of the participants of this community, allowing them, as well as outside observers, to check at any time: a list of positions within this community, and the list of individuals included in this community.

The present invention is intended to enable public monitoring of the activities of election commissions for the assembly and maintenance of voter lists, with the aim to exclude the possibility of uncontrolled entry into these lists of non-existent persons and persons who do not have the right to be voters.

### FIELDS OF THE INVENTION

The present invention relates to elections, specifically, voter registration with electronic voting systems using personal communication devices over a public network.

### BACKGROUND OF THE INVENTION

Due to the increasing use of personal smart devices, it has become attractive to use them to conduct online secret ballots which would be able to avoid many of the drawbacks inherent to traditional voting methods. With ubiquitous computing devices, multiple accidental errors and deliberate distortions could be avoided, and malicious actions from any parties involved in the voting process could be prevented.

However, numerous attempts to achieve this objective have proved futile. The set of problems that must be addressed when designing an online secret voting system is described in the article “Going from bad to worse: from Internet voting to blockchain voting”, published on Feb. 16, 2021 in the Journal of Cybersecurity, Volume 7, Issue 1, 2021 under the auspices of MIT by the authors Sunoo Park, Michael Specter, Neha Narula and Ronald L. Rivest. This publication was based on the analysis of more than 100 patents, reports on the operation of existing systems, and publications on developments in the field of remote electronic voting. This paper suggests that one of the most important unresolved and overlooked problems related to online voting is that the organizers of the vote may be able to manipulate the lists of those who have the right to (or can) vote, and, secondly, the lack of tools to counter such malicious actions.

Report and Recommendations of the Presidential Commission on Electoral Administration “The American Voting Experience”, published in January 2024, emphasized the importance of accurate voter registration, recommended that all states implement online voter registration, use it to expand the exchange of information on voter registration between states, seamlessly integrate voter data obtained through departments of motor vehicles. Following these recommendations, in 2024, online voter registration was introduced in 30 US states, herewith all innovations in the use of new computer technologies in the voter registration process were reduced to a number of patents for the use of documents and previous reliable registrations in this process.

### Open Questions Regarding Protection of Personal Data of Voters and its Composition

Doubts about the list of data required for identity verification are reflected in the patent U.S. Pat. No. 11,863,553B2 “Multi-factor identity verification” with priority dated Sep. 28, 2020, the inventors of which are Jay Nitturkar and Erika Eördögh. It suggests embodiments of systems, devices, and methods for multi-factor identity verification, which may include utilization of automated photo ID to Selfie matching, cross-reference address information, biometrics and geo-location information, and unique smartphone device identifiers.

The security of voter credentials is addressed in patent U.S. Pat. No. 20,210,288958A1, “Systems and methods for secure online credential authentication”, with priority 2016 Oct. 14, the inventor of which is Blake Hall. This patent proposes the preservation of personal data in the form of hashed identification information. During authentication, the information entered by the voter identifying themselves should be immediately translated into the same form. The identifying comparison should be made in this form.

U.S. Pat. No. 11,688,194B2, with priority dated Apr. 22, 2020, the inventor of which is Sebastien Bahlul, also offers a way to store information in an encoded format from an identity document, including photographs and other optically readable data.

### Registration by Document

One of prominent approaches behind online registration was based on comparing the image obtained in the registration process with the image in the person's official document presented during the registration and/or data in public and private databases considered reliable

U.S. Pat. No. 20,210,294880A1 with priority dated Mar. 24, 2018, the inventors of which are Vasilis Polychronidis, Adarbad Master, Michal Kepkowski, provides systems and methods for using programmatic means to verify the identity of a person based on the documents submitted by them and their biometric data. By scanning the person's documents and/or biometric data and comparing them to available government and private databases, the validity of these documents and the identity of the person can be confirmed with a high confidence level. The process can assign a score to each item verified which is then computed into an overall confidence score which is then available to other processes to rely on for approval of transactions. The identity is digitally combined with the credentials of the mobile phone to create a reusable identity token. Together with the confidence score, the identity token represents verified biometric information of the person and is tied to the mobile phone.

U.S. Pat. No. 20,220,138298A1 with priority dated Nov. 5, 2021, the inventors of which are Simon Law, Pasan Chankama Hapuarachchi, Phillip L. Kumnick, Thomas R. Szoke, Maxim Umarov, proposes a system that verifies the identity of a voter by comparing images of their face (for example, a selfie photo) and a scanned photo in a document certifying their identity. It determines the user's confidence status based on predefined thresholds using Fast Identity Online (FIDO) (pending).

U.S. Pat. No. 20,230,177508A1 with priority dated May 18, 2020, the inventor of which is Rikesh Ram, proposes a method and system for biometric authentication without requesting any personal information or device from a user. The system includes a registration module that allows the user(s) to register in the system. The input module receives registration information from the user(s), and the machine learning module compensates for blurring and poor image in the registration information. The verification module registers the user and creates a record, checking the registration information with the authority that issued the document. The liveliness detection module scans the user's face and creates a 3D map of their face in real-time. The authentication module verifies the user's identity by searching for a matching record between the face scans and saved records. The 3D face map is deleted after authentication (pending).

U.S. Pat. No. 20,230,316790A1 with priority dated Mar. 30, 2022, the inventors of which are Lukas Bayer, Can Wang, Dayron Rizo Rodriguez, Jason Richard Taylo, proposes a method for detecting fraud when a user sends an image of a photo identity card and a selfie taken during the verification process. The machine learning model can determine biometric data from selfies (for example, estimated age, gender, hair and eye color, etc.). The decision is made based on a comparison of the biometric data obtained from the selfie with the biometric data of the photo ID (pending).

U.S. Pat. No. 20,230,083852A1 with priority dated Nov. 14, 2022, the inventors of which are Abdelkader M′hamed, Benkreira Joshua Edwards, Michael Mossoba, proposes a system that verifies the identity of a voter. This system, firstly, compares a selfie image of the user's face and a photo in a document certifying their identity, secondly, recognizes data objects and symbols in this document using OCR and computer vision. After that, based on the results of the recognition process, this system identifies the type of document and calculates the validity index of this document. Then it displays the user's validity status, guided by predefined thresholds, based on the correspondence of images and the validity (pending).

However, the numerous proposals and developments carried out in the area of voter registration have in no way come close to countering malicious actions on the part of the organizers of voter registration. At the same time, the redundancy of the stored information used in the proposed systems for registration and subsequent authentication of voters creates prerequisites for its uncontrolled leakage and/or unauthorized publication in violation of personal data protection laws. The diversity of laws on different territories creates problems for creating equal conditions for the protection of this data. According to the National Conference of State Legislatures (NCSL) in the United States, the requirements for the concealment of personal data vary significantly from state to state. In 31 states, information about voters, which, in particular, includes information about name and place of residence, is available and can be purchased for money. In some states only parties can be purchasers, and in some any people. 20 states have introduced some restrictions on the dissemination of personal data to certain groups of voters. At the same time, in 44 states, an unlimited number of voters can demand to hide their address (https://www.ncsl.org/elections-and-campaigns/access-to-and-use-of-voter-registration-lists). It should be especially noted that in none of the states, an image of a person is mentioned as part of their personal data.

### Important Achievements

It should be noted that significant results have been achieved in facial recognition technology. It has become possible to distinguish even very similar people. That is, at the current level of development of machine intelligence, two people indistinguishable by computer systems do not exist. An example of such achievements is the system developed by TBS Biometrics, which distinguishes twins by iris, facial features or fingerprints, presented on the website https://www.youtube.com/watch?v=WV9drhFsT4l&t=11s.

Visualization services for the geographical locations of voters' residences is another prerequisite that can play a significant role in solving the problem of overcoming malicious actions on the part of organizers of voter registration. For example, the Google mapping service and/or a service implementing the patent U.S. Pat. No. 11,468,104B2 dated Feb. 22, 2016, which describes an integrated centralized real estate database system that includes a lot of time-varying information about real estate objects, each of which is linked to a specific geographical point on earth.

### SUMMARY OF THE INVENTION

All known systems for voter registration and maintenance of voter registers are aimed at creating a computer registration of voters, protecting personal data of voters, and providing registered voters with an anonymous certificate giving them the right and opportunity to vote. At the same time, inventions aimed at protecting against malicious actions of the organizers of voting and those who keep voter records are not known.

Our disclosed invention is based on the separation of those who technically support the system from those who conduct voter registration that is, using the system for voter registration. The persons supporting the system are responsible for its functioning and the non-disclosure of personal data of voters that are not subject to disclosure (for example, their places of residence). The persons conducting the registration of voters are responsible for filling in and maintaining the lists of voters and positions (for example, residence locations) that they may occupy. The purpose of the invention is to provide public control over voter registration without disclosing confidential voter data. Such control allows, firstly, to identify and hold accountable those who disclose personal data and those who distort or corrupt the voter lists, and secondly, to detect and correct these distortions.

The proposed invention is primarily intended for use in voting during elections and referendums carried out by government agencies and institutions. In these ballots, the number of persons eligible to vote in a certain territory includes all citizens registered at one of the locations in that territory. A potential malicious actor within a governmental institution or agency that keeps the records of residential locations (given by their addresses) and registers citizens at these locations might either include non-existent addresses among the addresses, registering non-existent people at these addresses or register non-existent people at existing addresses.

Along with the above, the proposed system and method can be effectively used to create communities of voters by any initiative groups acting as founders of such a community, whose members occupy positions whose composition and filling are controlled by both its members and outside observers. In case of such use, any type of voter positions can be specified, not just the location of their residence, the characteristics (parameters) of which are set by the founders.

One position may contain one or more vacancies, which may be occupied by multiple persons. The position may be the voter's current post or address (in such a position there may be one or many vacancies), or it may be the name of a particular person (where there is always one vacancy). It is convenient to use the addresses of voters' registration as the positions, which allows to verify the existence of such addresses and the absence of registration of non-existent persons (or persons who have no right to vote) at these addresses. It is clear that positions can be grouped into groups forming a hierarchy.

The system secretly stores just two interconnected lists: a list of positions indicating the number of places occupied in them and a list of images of community members. No other personal data is required by the system, which ensures that they cannot be leaked. In order to exercise public control, these two lists are published, but only without demonstrating the connection between them.

### DETAILED DESCRIPTION OF THE INVENTION

### Preliminary remarks

The terminology used herein is for the purpose of describing the particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In each claim, a number of individual actions are disclosed, each of which has an individual purpose, and can be used in combination with one or more, and in some cases, with all other disclosed individual actions. Accordingly, for greater clarity in this description, we will refrain from unnecessarily repeating all possible combinations of individual actions. With this in mind, the description and the claims should be read with the understanding that all such combinations fully correspond to the scope of the invention.

In this description, for purposes of explanation, numerous specific details are set forth in order to provide a thorough understanding of the present invention. It is evident, however, that the present invention may be practiced without these specific details.

The description and the claims of the invention disclose a number of methods and their constituent steps. Each of them has an individual advantage, and each of them can also be used in combination with one or more, and in some cases, with all other disclosed steps and methods. Accordingly, for greater clarity in this description, we will refrain from unnecessarily repeating all possible combinations of individual methods and stages. Nevertheless, the description and the claims of the invention should be read with the understanding that such combinations fully correspond to the scope of the invention.

This description should be considered as an illustration of the invention. It is not intended to limit the invention to the specific embodiments described below. The use of the phrases “either . . . or . . . ”, “in one of the options”, “in a particular case”, “maybe”, “for example,”, “etc.”, “perhaps” and the like serves to indicate that only one of the possible implementation options is presented, and that the presented option does not exclude, but suggests other options.

In this description and the claims of the invention “device” means any smart device of the user, which may be a personal computer, laptop, tablet, smartphone, etc. “Server” means any computer device, an association of computer devices or a software module, in particular a distributed one, performing the actions prescribed by this description. A “user” is a person who has a device connected to a public computer network. “Publishing” means any combination of the ability to view content using a computer device, the ability to visualize content on a display for the user to view it, and the ability to copy content. “Hidden saving” and “secretly saving” implies the inability to see the saved content by the user and the inability to copy or forward it. The combinations of the words “inseparable characteristic”, “inherent characteristics”, “essential features”, “inherent attributes”, and “inherent features” are used as synonyms. Each of these combinations relates to individual traits of a person-their appearance, biomarkers, behavior, etc. The combinations of the words “communities of voters” and “electoral community” are used as synonyms. A “list” means an unordered set of information records (entries) that fill in the positions in this list. The words “records” and “entries” in the context of list elements are used as synonyms.

### System

The system for creating, maintaining, and verifying voter lists (hereinafter referred to as the “system”) includes a support server and multiple personal smart devices with use a specific program, further referred to as an application, and are assembled into a network, which in one of the implementations may be a peer-to-peer network. A personal smart device (hereinafter referred to as a device) can be a personal computer, laptop, tablet, smartphone, etc. as well as a personalized software component installed on several devices. A support server (hereinafter referred to as a server) can be any computer device, a group of such devices or a module installed on such a device or devices.

The server provides: 1) the ability to receive and install on any personal computer device an application for participation in the registration; 2) maintaining a database containing information about a community or communities of voters; 3) access to select information from the database, in one of the implementations, visualization of this information on the system's public website; 4) in one of the implementations, transfer addresses of personal computer devices that have joined the network.

The application installed on a device includes the module of the founders of the electoral community, the registrar module, and the voter module. Each of them provides its own part of the functionality of a device. The founder's module enables the creation of a community of voters in a certain territory, a database of this community, and the establishment of relations between this base and the bases of other communities, which includes one database encompassing another. The registrar module allows to register a voter in a particular electoral community and ensures that the data is verified by the registrar. The voter module ensures that the data of the voter is recorded into the database of the electoral community, verification of this database and visualization of the results of this verification.

Since the user can use their own or any other device to log in, for the convenience of further presentation, the device through the founder's module on which the user authenticated and logged in will be called the “founder's device”; the device through the voter's module on which the user authenticated and logged in will be called the “voter's device”; the device through the registrar's module on which the user authenticated and logged in will be called the “registrar's device”. In the case of a registrar, it is appropriate (but not necessary) to provide the registrar's access to the system only from their personal device which retains their identifier.

### Filling in the Database

The founders of the electoral community-a group of individuals-create a board of founders and may exchange their images (or their essential features), which allows them to carry out mutual authentication for joint decision-making. By their decision, they create an electoral community, determine its type, assign it a name, attach it to their chosen territory, link it to other communities of voters attached to territories covering their chosen territory or embedded in it, and appoint persons authorized to conduct registration of voters in the territory indicated by them (hereinafter referred to as the “registrars”). The actions and decisions of the founders are carried out through the founder's module and are recorded on the server.

A user's image can be his photo or video portrait, for example, his face taken full-face. Since the main method of obtaining such an image is supposed to be a video selfie, further in this text, along with the term “image”, the term “selfie” will be used. The user's image in the system can complement any other essential feature inseparable from the user: a recording of their voice and/or a biomarker, etc.

The type of society refers to its specificity, which is reflected in the format of the positions that a user can occupy in this community. Voters can be residents of a town, state, or a large country, homeowners in a certain territory or shareholders in a certain enterprise, members of a party or a trade union, etc. Their positions can be the registration address, the title of their professional position, and the ownership relationship. In all such cases, more than one person may occupy the same position. A position can also be the voter's own name. There can only be one person in such a position. An example of a community with such positions is the academic council or a party cell with a known list of members.

For ease of understanding and clarity of presentation, further in the text, the functioning of the system is exemplified by voter registration at their physical addresses.

By the decision of the founders, a database of the voter community controlled by them is created on the server, which can be linked to the territory specified by the founders. In this case, this database can be attached to other databases linked to territories that cover or are nested in the one being created.

To protect a community database from malicious information inputs, encryption of any information entering the database with a public key from a key pair of asymmetric encryption specifically generated for this community can be used.

A registrar authorized to register voters in a community of voters in a certain territory can be assigned a unique number associated with this community.

A registrar authorized to register voters in a community of voters in a certain territory checks information about a user applying for registration in this community. The information being verified may include personal data of an individual-their last name, first name, patronymic, gender, date and place of birth, TIN, passport and driver's license data, insurance policy number, biometric information, registration and/or residence addresses, and the like. It also may include their contacts—phone number and/or email address, which provide feedback and two-factor identification. All this information is not recorded or stored in the system. After checking this information, the registrar decides whether this user is eligible to be registered as a voter in the particular community. In one of the implementations, having decided to register a user as a voter, the registrar, first, opens the forms on the user's device to enter their address and nickname, and second, sends the encryption key for registration in that community. If the voter community in which the user registers is a part of another community, the registrar can additionally send the public encryption key of this encompassing community.

A user applying for registration in a certain community of voters opens the voter module on their device and fills out the forms provided to them, where they enter their address, which must be located in the territory of the community in which they are willing to register (if a territory is specified for this community; the address entry form is needed to standardize their record and bring it in accordance with the format established by the founders). They take a selfie of their face, complement it with their voice print and biomarkers, and give the command to compare these files with the records in the voter database. The voter module checks the selfie taken by the user for a match with those selfies that are stored in the open list on the server. If there is a match between the images, the voter module compares the voice prints and biomarkers, and if the match persists, the voter module informs the registering user about this and blocks their registration in this community of voters.

If there are no matches, the voter module on their device asks the user for their nickname, which is forwarded to the registrar device. The registrar module on the registrar's device compares this nickname with nicknames stored in the closed voter database. If there are matches, the registrar module informs the registering user about this and provides them with the opportunity to change their nickname until the matches disappear. The registrar's module signs the original nickname with an electronic signature and sends it to the voter module on the registering user's device. After that, the voter module generates two files, in one of which it places an augmented selfie with a signed nickname, and in the other one-their address, also augmented with a signed nickname. In one implementation, the voter module encrypts both files with the public encryption key for this community, which it received from the registrar module, and sends them to the registrar module on the registrar's device.

After receiving two encrypted files from the registering user's module, the registrar module on the registrar's device sends them to the server along with a separate signed, but not encrypted, nickname and registrar ID.

The server decrypts the encrypted files received from the registrar module and places them in the section of the voter database corresponding to this community, which consists of two unconnected lists. Each entry (record) in these lists relates to one of the voters. One of these comprises addresses of the voters (in general, positions), the other one comprises their selfies. In one implementation, each record additionally contains a nickname. The number of records in these lists must match. In addition to these two lists, a separate closed list of nicknames is being formed, open to registrar modules for verification during the registration of a new voter. A signature and/or a unique number of this registrar is attached to each file received from a voter that has been verified by a specific registrar. The lists include only those images and addresses that are provided with signed nicknames that match the signed and unencrypted nicknames sent separately by the registrars.

When creating a community database in an encompassing territory, all community databases in nested territories may be included in the newly created one, provided that there are no intersections in the lists of voter selfies stored in these databases. If there are intersections in the lists of voters' selfies (that is, when the same user is registered as a voter in two or more territories), the registration of the community database in the encompassing territory occurs as follows: first, the correspondence of images and addresses in the lists of each of the communities in the nested territories is established by nicknames. Then, disjoint parts are highlighted in the image lists in all nested territories, after which these parts and their corresponding parts of the address lists are immediately entered into the encompassing database. In conclusion, one of the overlapping parts of the lists of images in different databases is selected, which is entered into the encompassing database along with a list of relevant addresses.

In the event that the voter community in which the user registers is a part of another community, the voter module on the voter's device checks the selfie taken by the user for a match with the selfies in the open list of the encompassing community. If there are no matches, then the voter module on the user's device additionally encrypts both files generated by it with the public encryption key for this encompassing community, also received from the registrar module, and sends them to the registrar module on the registrar's device for registration in the encompassing community. In the event that there is a match, the voter module on the device of the registering user only informs them about it. In other words, the selfies of the registering user and their address are only included in the lists of the encompassing community if they are not there yet. If they are there, then the selfie and address are entered only in the lists of the nested community, and they are not re-entered in the lists of the encompassing community.

Adding a user's selfie to the database, which the system cannot distinguish from one of the previously entered ones, and adding the address of this user in the same community is not allowed by the system. That is, no one can register in the same community of voters twice.

### Maintaining and Verifying the Voter Database

The server publishes the public part of the accumulated voter base of a certain territory on the website as it expands. The public part of the database includes two unconnected lists: 1) a list of voter addresses indicating for each address the number of voters registered at this address, and 2) a list of video selfies of all individuals registered in this territory and who have the right to vote. Voter nicknames (if stored in the database) are not published. The separate publication of the lists excludes the possibility for outsiders to connect the selfie of a person with the address of their registration. Publishing addresses can imply visualizing them in any convenient way, for example, as a list or marks on a map. In any case, the number of persons registered at each address is published for this address (just the number, not any information about these persons). In addition to these two lists, a separate hidden list of nicknames can be formed, which is open to registrar modules for verification during the registration of a new voter.

In one of the implementations as the accumulated voter database expands, the server divides it into parts, each of which is made up of two lists of the same size. All records in the database are marked with indexes reflecting their distribution by parts. At the same time, the server from the personal devices of registered voters forms groups of the same size. The server forwards several parts of the voter database to each device of the same group so that all devices of the same group have the same set of these parts. Thus, all database records are repeatedly copied and stored on a variety of voter devices. At the same time, a list of parts stored on it is generated on each device, and a registry of the distribution of parts by device is created on the server. The server sends this registry to the devices of all community members.

To avoid malicious or erroneous substitution of voter images and addresses, the devices of registered voters check the consistency of the database. During such a check, the device of a registered voter checks, firstly, the presence of this voter's selfie in the database, and secondly, the immutability of the stored by him part database on the server and on other devices that store the same part. This check is performed in the background.

Separate publication of the lists excludes the possibility for outman to associate a person's visual appearance with their address.

A necessary condition for the reliability of the voter lists in a certain territory is the coincidence of the number of persons registered at the addresses of this territory with the number of persons whose images are included in the list of persons entitled to vote in this territory.

The publication of two unconnected lists allows each registered voter and any eligible observer to verify the information contained therein. A registered voter can do this by three checks: checking the presence of their address in the list or addresses, checking the accuracy or sanity of the number of persons registered at this address, and, finally, checking the presence of their selfie in the list of selfies of registered participants (at the same time, they can search for their image stored in the database both using their selfie and nickname). Any eligible observer can check the presence or absence of non-existent addresses in the address list, and the presence or absence of clones (duplicates) in the image list.

### Making Changes

The inclusion of the founder in the founders and the admission of the registrar to his activities is carried out when their selfies are entered into the database by a unanimous decision of the founders. Adding a user's selfie to the database, based on which their authentication will be carried out during the voting process, is carried out by the user themselves, but under the control of the registrar.

The module on the user's personal device must be equipped with a recognition indicator, which will promptly notify the user that the system has stopped recognizing them, that is, their appearance has radically changed for the system. In this case, the user must take care of updating their appearance in the lists of the voter database. If they do not do this, they will lose their right to vote with the system. To make changes, the voter must contact the registrar, document their identity, and provide their new up-to-date image along with the saved old image, which, in one of the implementations, has a signed nickname attached (unlike the published images in the list of voters, which do not have nicknames attached). To make changes to their appearance, the registrar or founder must contact the Board of founders, whose decision will approve their new appearance.

If voting takes place regularly, and there have been no radical changes in the voter's appearance, then the last image of the voter will be saved for each authentication, that is, the voter images will be updated automatically. Thus, the lists of images of voters (persons who have the right to vote in a certain territory) will accumulate a history of changes in the appearance of each of them. The procedure applies to images of the registrars and founders.

If the user has died, moved, or renounced citizenship, then, at the time of registration of this event by government agencies, changes must be made to the database and both public lists of the database (the list of images and the list of addresses). The changes should be based on the documents provided by government agencies, which contain images and the address of the person who dropped out. The form of making such changes may be a mark of the retirement of such a user or the exclusion of the entries with their image and address from the database and public lists.

In the event of a change of residence, a voter who has moved to the territory of another community of voters, in order to exercise their right to vote in this territory, must register at a new address. Registration in two addresses in the same territory is not allowed, but registration in two different nested territories is possible, while the address of only one of the two nested territories is accepted as the address in the territory in which they are nested. In the case when, according to the decision of the founders of the community, registration in two different nested territories is prohibited, the voter should be allowed to determine which of these territories they will be registered in.

In one of the implementations, to make changes to the voter community database, nicknames signed by registrars are used, linking the hidden saved files to which they are attached. Claims

1. A system for creating and verifying voter lists, consisting of multiple devices connected in a network and configured to:
create by a person or group of persons a list and/or parameters of positions, the occupation of any of which relates the user to a voter community,
create and store a database of community members, and
publish the data from this database in the form that separately lists the positions indicating the number of participants occupying each of them, and community members represented by their essential features, for example, visual representations.

2. The system of claim 1, further comprising a server and personal smart devices connected into a peer-to-peer network, where the smart devices have software that includes the founder module, the registrar module, and the voter module.

3. The system of claim 1, further configured to repeatedly duplicate parts of the stored database of community members on the devices of community members.

4. The system of claim 1, additionally including a server configured to
store the list of founders of the community received from all the devices of these founders, where each of the founders is represented by their essential features, and
store the list of registrars received from all the devices of the founders of the community, in which each of the registrars is represented by their essential features and a unique registrar number and/or other identifier.

5. The system of claim 1, additionally including a server configured to
receive from the registrar's device a file with two files, one of which contains the name of the position occupied by the registering voter signed by the registrar, and the other one contains the essential features of this voter signed by the registrar, add the essential features and positions from these files to the database lists,
store in the concealed part of the database a list of filled vacancies within the positions (for example, a list of voter residence addressee which may contain duplicate entries), and a list of voter essential features (for example, selfies supplemented with a voiceprint and/or biomarker), where each record in these lists contains the registrar's identifier and the time this information was entered, main a list of registrars appointed and removed by the founders, and publish the list of positions indicating the number of appearances of each position, that is, the number of persons occupying this position (in particular, addresses indicating the number of appearances of each address, that is, the number of persons registered at this address) and a list of visualized essential features (for example, selfies).

6. The system of claim 1, additionally including a server configured to
receive from the registrar's device a file with a nickname signed by the registrar and two files, one of which contains the position occupied by the registering voter with a nickname attached to it signed by the registrar, and the other one contains the essential features of this voter with a nickname attached to it signed by the registrar,
check whether the nicknames signed by the registrar included in the files match with the nickname signed by the registrar and sent separately, and if they do match, add the essential features and positions from these files to the database and the public lists,
store several lists in the concealed part of the database, including a list of nicknames signed by the registrar, a list of filled vacancies within the positions (for example, a list of voter residence addressee which may contain duplicate entries), and a list of voter essential features (for example, selfies supplemented with a voiceprint and/or biomarker), where each record in these lists contains the registrar's identifier, the voter's nickname signed by the registrar and the time this information was entered,
main a list of registrars appointed and removed by the founders, and
publish the list of positions without nicknames indicating the number of appearances of each position with different nicknames, that is, the number of persons occupying this position (in particular, addresses indicating the number of appearances of each address, that is, the number of persons registered at this address) and a list of visualized essential features (for example, selfies) without nicknames.

7. The system of claim 1, additionally including a founder's module on personal user devices configured for
joint (cross-) registration of users as founders of the community and their subsequent authentication in this role,
creating and storing a list of founders in which they are represented by their essential features, adding entries to this list and excluding from this list, sending this list to the server,
joint decision-making by the founders, ( [symbol] [symbol] [symbol] [symbol] )
collective (by a joint decision of the founders) registration of the registrar and their admission to the system after each authentication, which confirms not only their identity, but also their liveliness, and
maintaining a list of registrars in which they are represented by their essential features and an identifier, adding entries to this list and excluding from this list, and sending this list to the server.

8. The system of claim 1, additionally including a registrar's module on personal user devices configured for
registration of the registrar and their subsequent authentication, which confirms not only their identity, but also their liveliness, by the means of the interaction of the registrar's device with the devices of the founders (for example, using the technology disclosed in the patent U.S. Pat. No. 20,240,244049A1), and
receiving two files from the voter module, signing them with the registrar's electronic signature, and sending the signed files to the voter's device, and to the server.

9. The system of claim 1, additionally including a registrar's module on personal user devices configured for
registration of the registrar and their subsequent authentication, which confirms not only their identity, but also their liveliness by the means of the interaction of the registrar's device with the devices of the founders (for example, using the technology disclosed in the patent U.S. Pat. No. 20,240,244049A1),
receiving a nickname from the module of a registering user, and, if there are no matches with the nicknames in the list of nicknames stored in the voter database, signing this nickname with the registrar's electronic signature and sending it to the server and the voter module on the voter's device,
receiving two files from the voter module, signing them with the registrar's electronic signature and sending the signed files to the voter's device, and
receiving two files from the voter module with a nickname signed by the registrar attached to each of these files, attaching the registrar's identifier to each of these files, and sending them to the server.

10. The system of claim 1, additionally including a voter's module on personal user devices configured for
entry by the voter of their own essential features, for example, selfies, and their storage,
comparison of the saved essential features of the voter with similar essential features that are stored in the public list of the voter database,
in case of the absence of coincidences of the compared features, creation of two files, a file with the position indicated by the voter and a file with the individual's essential features, saving and forwarding these files to the registrar module on the registrar's device.

11. The system of claim 1, additionally including a voter's module on personal user devices configured for
entry by the voter of their own essential features, for example, selfies, and their storage,
comparison of the saved essential features of the voter with similar essential features that are stored in the public list of the voter database,
in case of the absence of coincidences of the compared features, sending the nickname entered by the voter to the registrar's module on their device, and receiving this nickname back, signed with the registrar's electronic signature, and
creation of two files, a file with the position to which the nickname signed by the registrar is attached, and a file with the individual's essential features to which the nickname signed by the registrar is attached, saving and forwarding these files to the registrar module on the registrar's device.

12. The system of claim 1, additionally including a voter's module on personal user devices configured to
compare the number of entries in the list of members of a selected community, and the list of all registrations in all positions in this community (for example, a list of registration addresses),
search the list of members' essential features in the database of community members for the user's essential features, and
visualize the search and comparison results and, send these results to the server and devices of community members.

13. The system of claim 1, additionally including a server configured to maintain a distributed database by
splitting each of the two published lists into equal parts, each of which (except the last) contains a selected number of entries, providing each of these parts with an index and its own hash,
sending the parts of the published lists to the devices of the members of the voter community in such a way that each part of one list is located on several devices, and
creating a registry of distributing parts of the database by the devices of community members and sending this registry to the devices of community members.

14. The system of claim 1, additionally including a voter's module on a personal user devices configured to maintain a distributed database by receiving from the server and saving a part of the database with the index of this part and the registry of distributing parts of the database by the devices of community members.

15. The system of claim 1 additionally including a voter's module on personal user devices configured to maintain a distributed database by
checking the completeness and immutability of the database on the server by periodically or occasionally checking the part of this database received from the server or its hash function with the original of this part stored by the server or its hash function, and
checking the completeness and immutability of the database on the server by sequentially retrieving parts of the database stored on the server and comparing each of these parts with the part requested from a randomly selected device storing this part and connected to the network at the time of the request.

16. A method for creating and verifying voter lists, in which voters are users who occupy specified positions, the method comprising:
creating by any user or a group of users a voter's community by setting a list and/or parameters of positions, each of which relates a user who occupies this position to this community, and
creating and storing a database of this community, and publication of data from this database in the form of two unconnected lists, one of which contains positions indicating the number of participants occupying each of them, and the other one contains community members represented by their inherent characteristics, in a particular case, visual.

17. The method of claim 16, further comprising:
connecting the founders' devices into a peer-to-peer network,
exchanging essential features of the devices' owners (in a particular case, visual) by the founders' devices,
using the founders' devices for cross-authentication of the founders,
establishing, by a decision of the founders, features of the community, which may include its name and links with other communities, and
establishing, by a decision of the founders, the composition of public information about the founders and the community.

18. The method of claim 16, further comprising:
creating by the founders of a voter community a list of registrars represented by their essential features,
adding new registrars to this list and/or deleting the previously entered ones by the decision of the founders,
saving the list of registrars on the founders' devices and the server,
generating a unique identifier for each registrar, saving this identifier on the registrar's device, as well as in the list of registrars on the server and the founders' devices, and
admitting the registrar's device to perform registrar functions in the voter community after the registrar is authenticated by the founders' devices.

19. The method of claim 16, further comprising importing, by decision of the founders, data from other databases into the database of community members.

20. The method of claim 16, further comprising:
verification by the registrar of the validity of the information provided by a registering voter and the absence of coincidences of this information with the information stored in the voter database,
certification by the registrar (signing with their electronic signature) of the information submitted by the registering voter, in the case of validity of this information, and the absence of coincidences of this information with the information stored in the voter database, and saving information certified by the registrar in the database.

21. The method of claim 16, further comprising:
sending two files by the voter module on the voter's device to the registrar module on the registrar's device: a file of the position occupied by this voter, and a file with its essential features (for example, a selfie or a selfie supplemented with a voice print and/or a biomarker),
checking by the registrar module the received the file with essential features for coincidence with essential features of voters stored in the base,
signing both files with the registrar's electronic signature in the absence of matches and confirmation by the registrar of, first, the authenticity of the position specified by the registering voter, and, second, the essential features of the registering voter, and forwarding the signed files from the registrar's device to the server and the device of the registering voter,
adding files received by the server from registrars of a certain community to the list of the occupied vacancies in the positions (for example, in the form of duplicate addresses), and to the list of essential features of a voter (for example, selfies supplemented with a voice print and/or biomarker), and secretly saving these lists in the database of this community while maintaining the connection between the essential features of each voter and their vacancy in the position, and
publication on the site of two separate lists: a list of positions indicating the number of appearances of each position, that is, the number of persons occupying this position (for example, in the form of a map containing all the places of residence with an indication of the number of people registered in each such place), and a list of essential features of the voter (for example, selfies) without the identification number.

22. The method of claim 16, further comprising:
sending three files by the voter module on the voter's device to the registrar module on the registrar's device: a file of the position occupied by this voter, a file with the nickname of this voter, and a file with the voter's essential features (for example, a selfie),
checking the received two files by the registrar module, the file with the nickname and the file with essential features, for coincidence with nicknames and essential features of voters stored in the database of the voter community,
saving these three files by the voter's device, attaching to two of them-the position file and the file with essential features-his nickname signed by the registrar, and sending these two files to the registrar's device,
getting by the registrar's device two files from the device of the voter verified, attaching the registrar's identifier to each of them, and sending them to the server along with the signed nickname of this voter,
creating a non-public database by the server from files received by it from registrar devices of a certain community, comprising a list of nicknames signed by the registrar, a list of vacancies occupied in the positions assigned for this community, where each record in the list additionally contains registrar's identifier and the voter's nickname signed by the registrar, and a list of essential features of the voters, where each record in the list additionally contains the registrar's identifier and the voter's nickname signed by the registrar, and
publishing two separate lists: a list of positions without nicknames indicating the number of appearances of each position, that is, the number of persons occupying this position (for example, in the form of a map containing all the places of residence with an indication of the number of people registered in each such place), and a list of essential features of the voters (for example, selfies) without nicknames.

23. The method of claim 16 further comprising publishing lists of positions and essential features not immediately after adding new data to these lists, but either at selected or random time instants or after accumulating a selected amount of new data.

24. The method of claim 16, further comprising:
generating a pair of encryption keys consisting of a public key and a private key identifying the voter community, saving this key pair on the server and devices of the founders,
sending the public encryption key by the server to the registrar module on the registrar's devices,
encrypting by the registrar's device two files provided by a registering voter, attaching the registrar's identifier to these files, sending them to the server, and
decrypting by the server the two files of the registered voter, equipped with the registrar's identifier received by the server, saving these files in the database, and publishing them in two separate lists.

25. The method of claim 16 further comprising:
verifying by the voter module on the voter's device the presence of the voter's essential features (in a special case, a selfie) in the database of the voter community in which the voter is registered,
verifying by the voter's device the absence of coincidence of selfies in the database of the voter community in which the voter is registered,
determining by the voter module on the voter's device the number of all represented by their essential features (in a particular case, selfies) and the total number of occupied vacancies for all positions entered into the database of the voter community in which the voter is registered, and comparing these numbers with each other, and
visualizing the results of the verification and comparison by the voter module on the voter's device.

26. The method of creating and verifying voter lists, which includes
distributed storage of the public (open) section of the voter community database by dividing the database into parts, creating numerous copies of each part and sending these copies to the devices of community members for storage, and
distributed storage of the non-public (hidden) section of the voter community database, by dividing it into parts, creating multiple copies of each part, and sending these copies to the devices of community members for storage in encrypted form.

27. The method of claim 26 further comprising:
splitting by the server the lists with data from members of the voter community stored in the voter community database into equal parts, each of which (except the last one) contains a selected number of records, each of which refers to one member of the voter community, and supplying each of these parts with an index,
cloning the voter community database, that is sending by the server parts of the public lists to the devices of the members of this community in such a way that each part of one list arrives at a variety of devices,
creating by the server a registry of the parts of the voter community database, which comprises a list of indexes of the database parts,
attaching to each index of the database part in the registry a hash of the part corresponding to this index and, in one of the implementations, network addresses of those devices to which the part corresponding to this index was sent,
distributing this registry to the devices of community members,
receiving by the voter device parts of the voter community database equipped with their indexes, as well as the registry of distribution of the database parts, and
saving by the voter device in a repository to which the device has access, in one of the implementations, in a designated repository access to which is open to devices of authenticated voters to the voter community, parts of the database received from the server and the registry of distribution of these parts received from the server.

28. The method of claim 26, further comprising:
verification by the voter module on the voter's device of the completeness and immutability of the voter community database stored by the server, by comparing one or several parts of this database stored by the voter's device with their origins stored by the server,
verification by the voter module on the voter's device of the completeness and immutability of the voter community database by comparing the hashes of parts of the database stored by the server (and, in a separate implementation, by other devices) with the hashes of the database parts in the registry stored by the voter's device, and
restoring lost or distorted parts of the database from multiple copies of these parts on the devices of the voters.

29. The method of claim 26, further comprising updating by the voter's device a part of the voter community database stored by the voter's device after verifying by this voter's device that the server published the changes in this part.
